(19) United States
(12) Patent Application Publication
(10) Pub. No.: US 2006/0236219 A1
(43) Pub. Date: Oct. 19, 2006

(54) Media timeline processing infrastructure

(75) Inventors: Alexandre V. Grigorovitch, Redmond, WA (US); Shafiq Ur Rahman, Redmond, WA (US); Sohail Baig Mohammed, Redmond, WA (US); Geoffrey T. Dunbar, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/109,291

(22) Filed: Apr. 19, 2005

(51) Int. Cl. G06F 17/00

(52) U.S. Cl. 715/500.1

(57) ABSTRACT

A media timeline processing infrastructure is described. In an implementation, one or more computer readable media include computer executable instructs that, when executed, provide an infrastructure having an application programming interface that is configured to accept a plurality of segments from an application for sequential rendering. Each of the segments reference at least one media item for rendering by the infrastructure and each segment is taken from a media timeline by an application.

### TECHNICAL FIELD

The present invention generally relates to media, and more particularly relates to a media timeline processing infrastructure.

### BACKGROUND

Users of computers, such as desktop PCs, set-top boxes, personal digital assistants (PDAs), and so on, have access to an ever increasing amount of media from an ever increasing variety of sources. For example, a user may interact with a desktop PC that executes a plurality of applications to provide media for output, such as home videos, songs, slideshow presentations, and so on. The user may also utilize a set-top box to receive traditional television programming that is broadcast to the set-top box over a broadcast network. Additionally, the set-top box may be configured as a personal video recorder (PVR) such that the user may store the broadcast content in memory on the set-top box for later playback. Further, the user may interact with a wireless phone that executes a plurality of applications such that the user may read and send email, play video games, view spreadsheets, and so forth.

Because of the wide variety of media sources and the wide variety of computers that may be utilized to provide and interact with media, traditional applications and computers were often configured to specifically address each particular type of media. For example, applications that were executed on a video-game console to output video-games were typically configured to provide an output of the applications to a television, and were not configured to provide the output that could be utilized by other computers and other devices. Therefore, presentation of content that was provided by the different media sources, such as computers and/or applications, may involve multiple applications and devices which may be both time and device intensive. Additionally, multiple applications that were executed on the same computer may be configured to specifically address the particular type of media provided by each respective application. For instance, a first audio playback application may be configured to output media configured as songs. A second audio playback application, however, may be configured to record and playback the recordings in an audio format that is not compatible with the first audio playback application, such as an audio-dictation format. Thus, even applications that are configured for execution on the same computer and the same type of media, e.g. audio, may provide media that is incompatible, one to another.

A timeline provides a way for a user to define a presentation of media. For example, a media player can play a list of songs, which is commonly referred to as a “playlist”. Traditional timelines, however, were limited by the wide variety of media sources and the wide variety of computer configurations that may be utilized to provide and interact with media. When desiring the output of different types of media, for instance, each application needed to “understand” each type of media, such as how to render the particular type of media. This may result in an inefficient use of both hardware and software resources of the computer.

Accordingly, there is a continuing need to provide improved techniques for processing media timelines.

### SUMMARY

A media timeline processing infrastructure is described. In an implementation, a method is described in which an application is executed to derive a plurality of segments from a media timeline. The media timeline references a plurality of media and each of the segments references media to be rendered during a duration of the segment. The application is executed to queue the plurality of segments for rendering by an infrastructure.

In another implementation, one or more computer readable media include computer executable instructs that, when executed, provide an infrastructure having an application programming interface that is configured to accept a plurality of segments from an application for sequential rendering. Each of the segments reference at least one media item for rendering by the infrastructure and is a segment taken by the application from a media timeline.

### BRIEF DESCRIPTION OF THE DRAWINGS

FIG. 1 is an illustration of an environment in an exemplary implementation in which a computer provides access to a plurality of media.

FIG. 2 is a high level block diagram of a system in an exemplary implementation in which the system, implemented in software, includes an application that interacts with a media foundation to control presentation of a plurality of media.

FIG. 3 is an illustration of an exemplary implementation of a system that shows interaction between the application, a sequencer source and a media session of FIG. 2.

FIG. 4 is an illustration of an exemplary implementation in which a media timeline is shown as a tree that includes a plurality of nodes that provide for an output of media for a presentation.

FIG. 5 is an illustration of an exemplary implementation showing a sequence node and a plurality of leaf nodes that are children of the sequence node.

FIG. 6 is an illustration of an exemplary implementation showing a parallel node and a plurality of leaf nodes that are children of the parallel node.

FIG. 7 is a flow diagram depicting a procedure in an exemplary implementation in which an application interacts with a media session and a sequencer source to cause a media timeline configured as a playlist to be rendered.

FIG. 8 is an illustration of an exemplary implementation showing an output of first and second media over a specified time period that utilizes an effect to transition between the first and second media.

FIG. 9 is an illustration of a media timeline in an exemplary implementation that is suitable to implement a cross fade effect of FIG. 8.

FIG. 10 is an illustration of an exemplary implementation showing a plurality of segments derived from the media timeline of FIG. 9 by an application for rendering by the media timeline processing infrastructure.

FIG. 11 is a flow diagram depicting a procedure in an exemplary implementation in which an application segments a media timeline into a plurality of topologies for rendering by the media timeline processing infrastructure.

FIG. 12 is an illustration of an exemplary operating environment.

FIG. 13 is an illustration of an exemplary implementation showing a media timeline that includes a sequence node and three leaf nodes described by a Windows® Media Player Playlist file identified by an ASX file extension.

FIG. 14 is an illustration of an exemplary implementation showing a media timeline that includes a parallel node having two child sequence nodes that are described by an eXecutable Temporal Language (XTL) file.

The same numbers are used throughout the disclosure and figures to reference like components and features.

### DETAILED DESCRIPTION

Overview

A media timeline processing infrastructure is described. A media timeline provides a technique for a user to define a presentation based on media, such as already existing media (e.g., stored media such as video, songs, documents, and so on) and/or media that is output in “real-time” from a media source, such as streaming audio and/or video. The media timeline may be utilized to express groupings and/or combinations of media and provide compositional metadata utilized by media timeline processing infrastructure that executes, e.g. renders, the media referenced by the media timeline to provide a final presentation.

Different multimedia applications may have different media timeline object models for dealing with collections of media. For example, a media player may use a playlist in order to play media in sequence. On the other hand, an editing application may use a media timeline configured as a storyboard to edit a presentation of the media. Yet another application may utilize an event based timeline, where media playback jumps between items based on certain events. Accordingly, a wide variety of media timeline object models may be encountered which are different, one to another, such that each application may have its own custom media timeline solution.

In an implementation, a media timeline processing infrastructure is described which provides “base level” support for applications such that the applications may render the media timelines which are particular to the application. For example, the media timeline processing infrastructure may be configured to allow an application to queue media segment which does not change over a period of time but have the infrastructure itself “figure out” how to render the segment. In another example, the media timeline processing infrastructure is configured to allow an application to cancel or update segments “on the fly” during rendering of the segment, with the infrastructure handling all the nuances of updating the rendering of the segment as needed. Thus, an application in contact with the media timeline processing infrastructure need only concentrate on the specifics of the particular media timeline object model for that application by translating the media timeline into a sequence of segments which are understood by the media timeline processing infrastructure.

In the following discussion, an exemplary environment is first described which is operable to employ the media timeline processing infrastructure. Exemplary procedures are then described which are operable in the exemplary environment, as well as in other environments.

Exemplary Environment

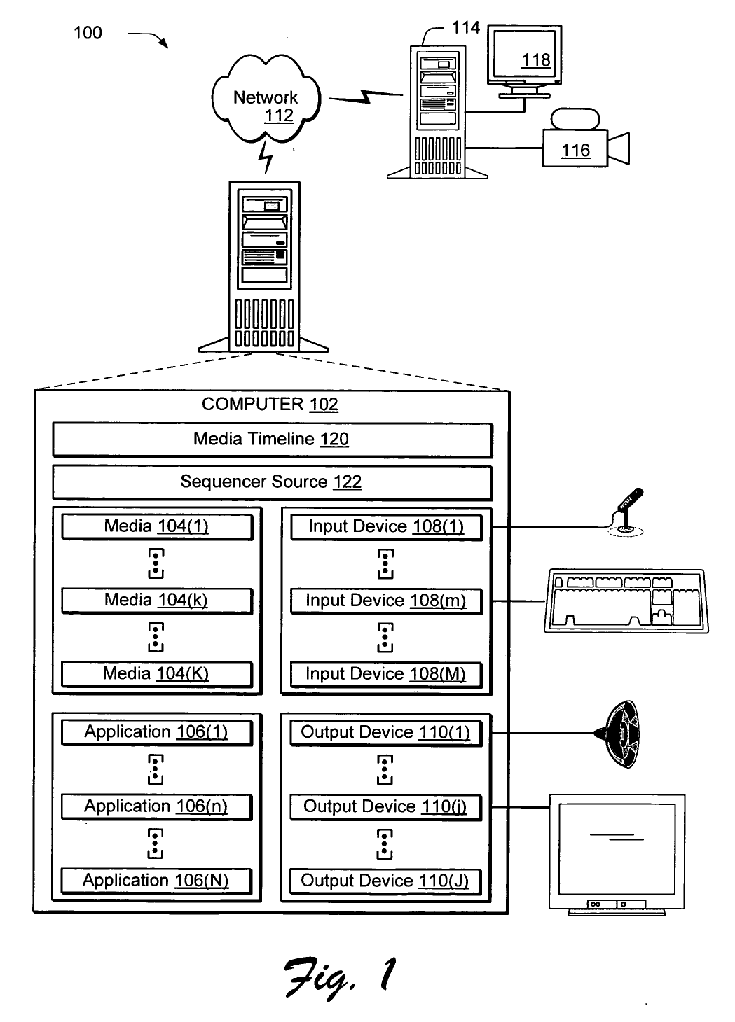

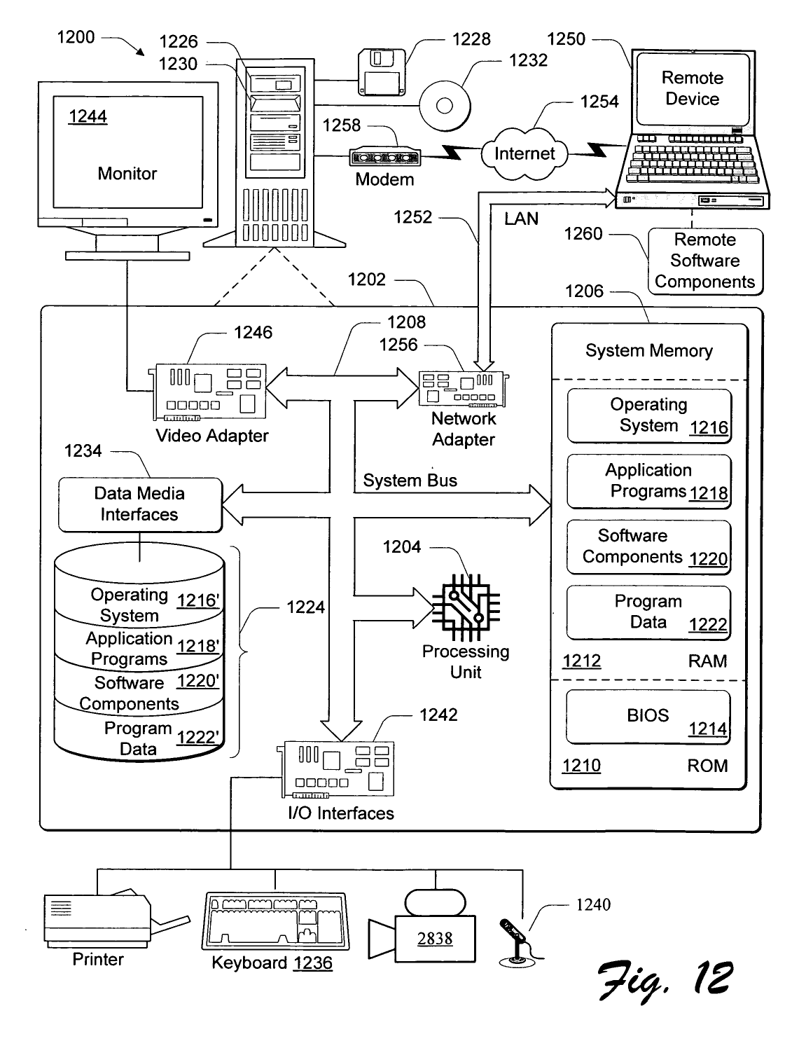

FIG. 1 is an illustration of an environment 100 in an exemplary implementation in which a computer 102 provides access to a plurality of media. The computer 102, as illustrated, is configured as a personal computer (PC). The computer 102 may also assume a variety of other configurations, such as a mobile station, an entertainment appliance, a set-top box communicatively coupled to a display device, a wireless phone, a video game console, a personal digital assistant (PDA), and so forth. Thus, the computer 102 may range from a full resource device with substantial memory and processor resources (e.g., PCs, television recorders equipped with hard disk) to a low-resource device with limited memory and/or processing resources (e.g., a traditional set-top box). An additional implementation of the computer 102 is described in relation to FIG. 12.

The computer 102 may obtain a variety of media from a variety of media sources. For example, the computer 102 may locally store a plurality of media 104(1), . . . , 104(k), . . . , 104(K). The plurality of media 104(1)-104(K) may include an assortment of audio and video content having various formats, such as WMV, WMA, MPEG 1, MPEG 2, MP3, and so on. Further, the media 104(1)-104(K) may be obtained from a variety of sources, such as from an input device, from execution of an application, and so on.

The computer 102, for instance, may include a plurality of applications 106(1), . . . , 106(n), . . . , 106(N). One or more of the plurality of applications 106(1)-106(N) may be executed to provide media, such as documents, spreadsheets, video, audio, and so on. Additionally, one or more of the plurality of applications 106(1)-106(N) may be configured to provide media interaction, such as encoding, editing, and/or playback of the media 104(1)-104(K).

The computer 102 may also include a plurality of input devices 108(1), . . . , 108(m), . . . , 108(M). One or more of the plurality of input devices 108(1)-108(M) may be configured to provide media for input to the computer 102. Input device 108(1), for instance, is illustrated as a microphone that is configured to provide an input of audio data, such as a voice of the user, a song at a concert, and so on. The plurality of input devices 108(1)-108(M) may also be configured for interaction by a user to provide inputs that control execution of the plurality of applications 106(1)-106(N). For example, input device 108(1) may be utilized to input voice commands from the user, such as to initiate execution of a particular one of the plurality of applications 106(1)-106(N), control execution of the plurality of applications 106(1)-106(N), and so forth. In another example, input device 108(m) is illustrated as a keyboard that is configured to provide inputs to control the computer 102, such as to adjust the settings of the computer 102.

Further, the computer 102 may include a plurality of output devices 110(1), . . . , 110(j), . . . , 110(J). The output devices 110(1)-110(J) may be configured to render media 104(1)-104(K) for output to the user. For instance, output device 110(1) is illustrated as a speaker for rendering audio data. Output device 110(j) is illustrated as a display device, such as a television, that is configured to render audio and/or video data. Thus, one or more of the plurality of media 104(1)-104(K) may be provided by the input devices 108(1)-108(M) and stored locally by the computer 102. Although the plurality of input and output devices 108(1)-108(M), 110(1)-110(J) are illustrated separately, one or more of the input and output devices 108(1)-108(M), 110(1)-110(J) may be combined into a single device, such as a television having buttons for input, a display device, and a speaker.

The computer 102 may also be configured to communicate over a network 112 to obtain media that is available remotely over the network 112. The network 112 is illustrated as the Internet, and may include a variety of other networks, such as an intranet, a wired or wireless telephone network, a broadcast network, and other wide area networks. A remote computer 114 is communicatively coupled to the network 112 such that the remote computer 114 may provide media to the computer 102. For example, the remote computer 114 may include one or more applications and a video camera 116 that provides media, such as home movies. The remote computer 114 may also include an output device to output media, such as the display device 118 as illustrated. The media obtained by the computer 102 from the remote computer 114 over the network 112 may be stored locally with the media 104(1)-104(K). In other words, media 104(1)-104(K) may include locally stored copies of media obtained from the remote computer 114 over the network 112.

Thus, the computer 102 may obtain and store a plurality of media 104(1)-104(K) that may be provided both locally (e.g., through execution of the plurality of applications 106(1)-106(N) and/or use of the plurality of input device 108(1)-108(M)), and remotely from the remote computer 114 (e.g., through execution of application and/or use of input devices). Although the plurality of media 104(1)-104(K) has been described as stored on the computer 102, the media 104(1)-104(K) may also be provided in “real-time”. For example, audio data may be streamed from the input device 108(1), which is illustrated as a microphone, without storing the audio data.

The computer 102 is illustrated as including a media timeline 120. As previously described, the media timeline 120 provides a technique for a user to define a presentation of stored and/or real-time media from the plurality of media sources. For example, the media timeline 120 may describe a collection of media that was obtained from the input devices 108(1)-108(M), the applications 106(1)-106(N), and/or the remote computer 114. The user, for instance, may utilize one or more of the input devices 108(1)-108(M) to interact with the application 106(n) to define groupings and/or combinations of the media 104(1)-104(K). The user may also define an order and effects for presentation of the media 104(1)-104(K). A sequencer source 122 may then be executed on the computer 102 to render the media timeline 120. The media timeline 120, when rendered, provides the expressed groupings and/or combinations of the media 104(1)-104(K) for rendering by one or more of the plurality of output devices 110(1)-110(J). Further discussion of execution of the sequencer source 122 may be found in relation to the following figures.

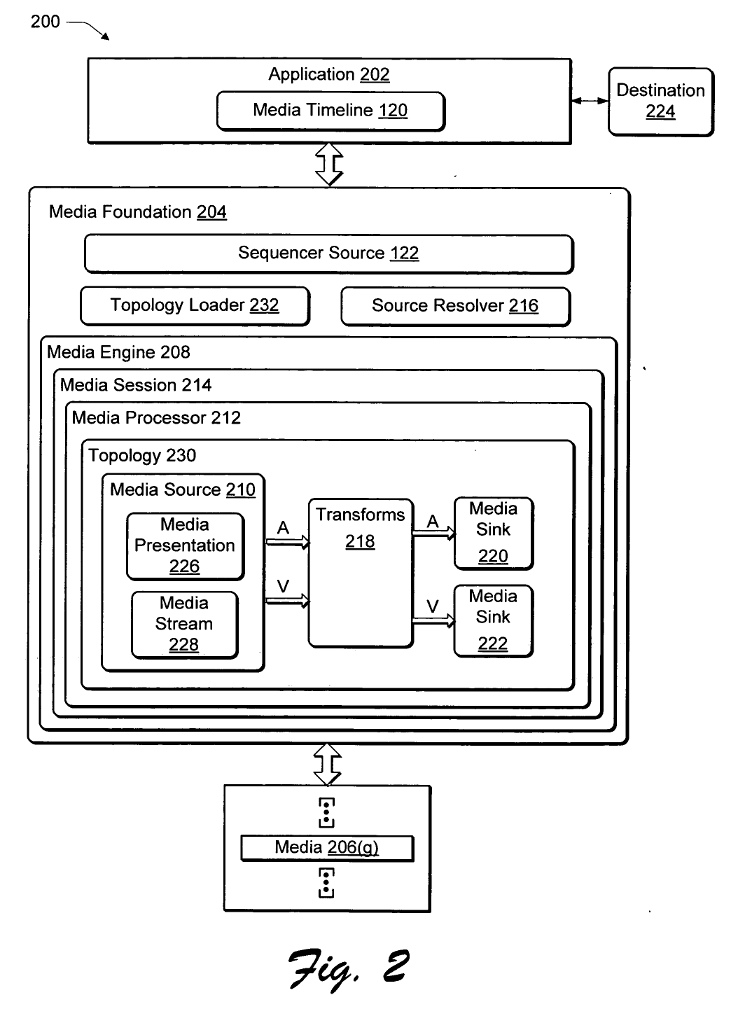

FIG. 2 is a high level block diagram of a system 200 in an exemplary implementation in which the system 200, implemented in software, includes an application 202 that interacts with a media foundation 204 to control presentation of a plurality of media 206(g), where “g” can be any number from one to “G”. The media foundation 204 may be included as a part of an operating system to provide playback of the media 206(g) such that applications that interact with the operating system may control playback of the media 206(g) without “knowing” the particular details of how the media is rendered. Thus, the media foundation 204 may provide a portion of a media timeline processing infrastructure to process a media timeline 120 of the application 202 The media 206(g) may be provided from a variety of sources, such as from the media 104(1)-104(K) of FIG. 1, through execution of the applications 106(1)-106(N), use of the input devices 108(1)-108(M), output devices 110(1)-100(J), and so on.

The application 202, which may be the same as or different from applications 106(1)-106(N) of FIG. 1, interacts with a media engine 208 to control the media 104(1)-104(K). In at least some embodiments, the media engine 208 serves as a central focal point of the application 202 that desires to somehow participate in a presentation. A presentation, as used in this document, refers to or describes the handling of media. In the illustrated and described embodiment, a presentation is used to describe the format of the data on which the media engine 208 is to perform an operation. Thus, a presentation can result in visually and/or audibly presenting media, such as a multimedia presentation in which both audio and accompanying video is presented to user within a window rendered on a display device, such as output device 110(j) of FIG. 1 that is illustrated as a display device that may be associated with a desktop PC. A presentation can also result in writing media content to a computer-readable medium such as a disk file. Thus, a presentation is not limited to scenarios in which multimedia content is rendered on a computer. In some embodiments, operations such as decoding, encoding and various transforms (such as transitions, effects and the like), can take place as a result of a presentation.

In an embodiment, the media foundation 204 exposes one or more application program interfaces that can be called by the application 202 to render the media 206(g). For example, the media foundation 204 may be thought of as existing at an “infrastructure” level of software that is executed on the computer 102 of FIG. 1. In other words, the media foundation 204 is a software layer used by the application 202 to present the media 206(g). Thus, the media foundation 204 may be utilized such that each application 202 does not have to implement separate code for each type of media 206(g) that may be used in the system 200. In this way, the media foundation 204 provides a set of reusable software components to do media specific tasks.

The media foundation 204 may utilize several components among which include the sequencer source 122, a media source 210, a media processor 212, a media session 214, the media engine 208, a source resolver 216, one or more transforms 218, one or more media sinks 220, 222, and so on. One advantage of various illustrated and described embodiments is that the system 200 is a pluggable model in the sense that a variety of different kinds of components can be utilized in connection with the systems described herein. Also included as a part of system 200 is a destination 224, which is discussed in more detail below. In at least one embodiment, however, the destination 224 is an object that defines where a presentation is to be presented (e.g. a window, disk file, and the like) and what happens to the presentation. That is, the destination may correspond to one or more of the media sinks 220, 222 into which data flows.

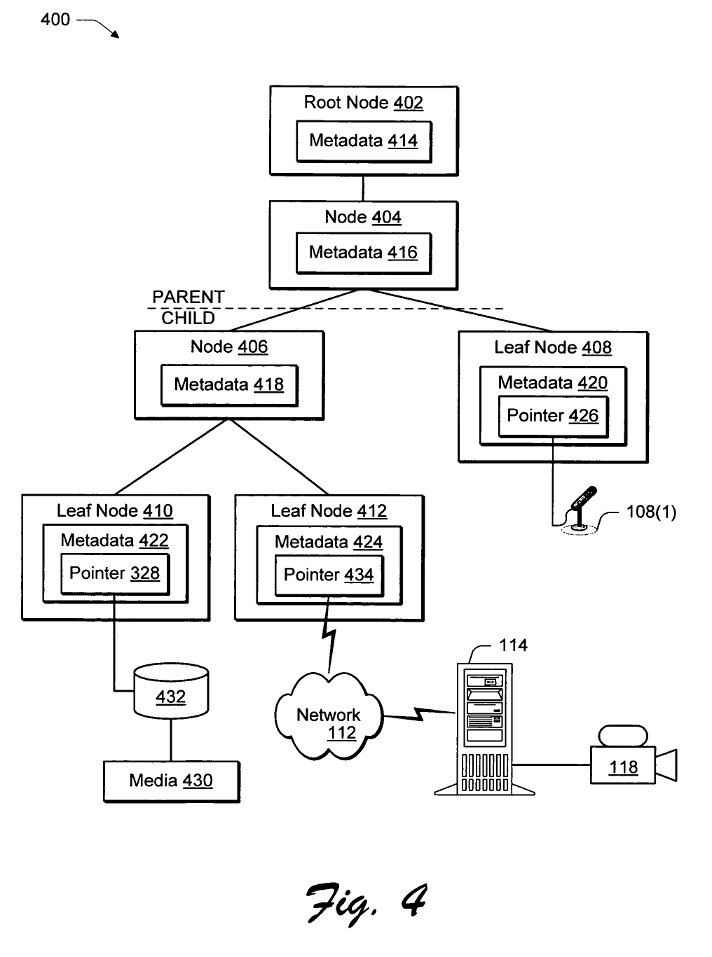

The media timeline 120 is illustrated as a part of the application 202. The media timeline 120 may be configured in a variety of ways to express how a plurality of media is to be rendered. For example, the media timeline may employ an object model which provides a way for a user of the application 202 to define a presentation based on media that is rendered by the media foundation 204. The media timeline 120, for instance, may range from a sequential list of media files to more complex forms. For example, the media timeline 120 may employ file structures, such as SMIL and AAF, to express media playback experiences that include transitions between media, effects, and so on. The application 202, for instance, may be configured as a media player that can play a list of songs, which is commonly referred to as a playlist. As another example, in an editing system a user may overlay one video over the other, clip a media, add effect to the media and so forth. Such groupings or combinations of media may be expressed using the media timeline 120. Further discussion of the media timeline 120 is found beginning in relation to FIG. 4.

The media source 210 is utilized to abstract a provider of media. The media source 210, for instance, may be configured to read a particular type of media from a particular source. For example, one type of media source might capture video from the outside world (e.g., a camera), and another might capture audio (e.g., a microphone). Alternately or additionally, the media source 210 may read a compressed data stream from disk and separate the data stream into its compressed video and compressed audio components. Yet another media source 210 might obtain data from the network 112 of FIG. 1. Thus, the media source 210 may be utilized to provide a consistent interface to acquire media.

The media source 210 provides one or more media presentation 226 objects (media presentation). The media presentation 226 abstracts a description of a related set of media streams. For example, the media presentation 226 may provide a paired audio and video stream for a movie. Additionally, the media presentation 226 may describe the configuration of the media source 210 at a given point in time. The media presentation 226, for instance, may contain information about the media source 210 including descriptions of the available streams of the media source 210 and their media types, e.g. audio, video, MPEG, and so on.

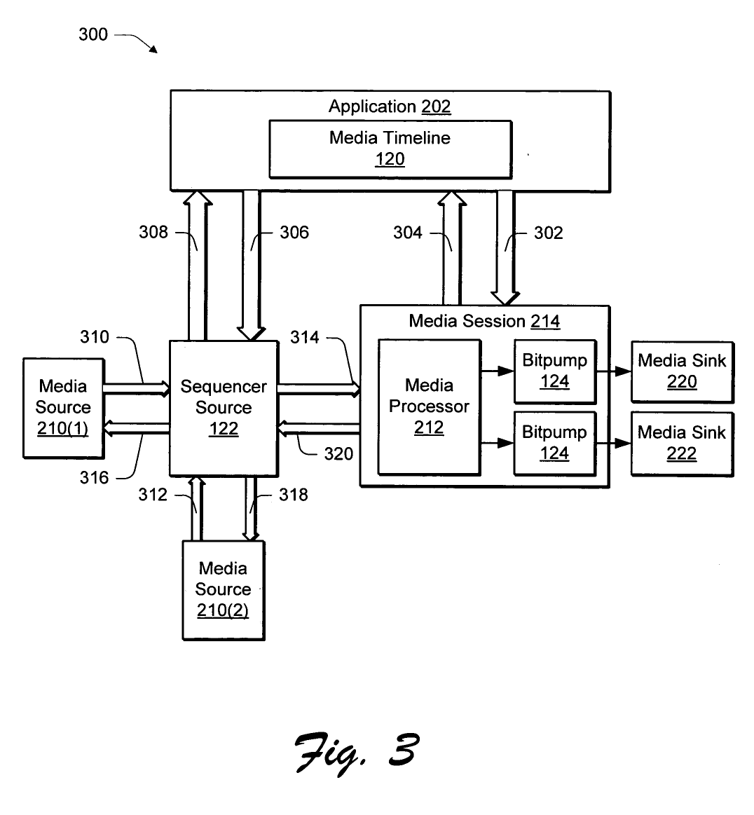

The media source 210 may also provide a media stream 228 object (media stream) which may represent a single stream from the media source 210 which can be accessed by the application 202, i.e. exposed to the application 202. The media stream 228 thus allows the application 202 to retrieve samples of the media 206(g). In an implementation, the media stream 228 is configured to provide a single media type, while the sequencer source 122 may be utilized to provide multiple media types, further discussion of which may be found in relation to FIG. 3. A media source can provide more than one media stream. For example, a wmv file can have both audio and video in the same file. The media source for this file will therefore provide two streams, one for audio and the other for video. In the media foundation 204, therefore, the media source 210 represents a software component which outputs samples for a presentation.

The sequencer source 122 is configured to receive segments from the application 202, which then queues the segments on the media session 214 to cause the segments to be rendered. Thus, the sequencer source 122 may be utilized to hide the intricacies of rendering the media timeline 120 to provide media described by the media timeline 120 from other components of the media foundation 204.

The segments received by the sequencer source 122, for instance, may be utilized to create a topology 230 from segments received by the application 202. The topology 230 defines how data flows through various components for a given presentation. A “full” topology includes each of the components, e.g. software modules, used to manipulate the data such that the data flows with the correct format conversions between different components. The sequencer source 122 interacts with the media session 214, which handles “switching” between consecutive topologies for rendering by the media processor 212. For example, the sequencer source 122 may “queue” the topology 230 on the media session 214 for rendering. Further discussion of the interaction of the sequencer source 122, application 202 and the media session 214 may be found in relation to FIG. 3.

When a topology is created, the user might choose to create it partially. This partial topology is not sufficient, by itself however, to provide a final presentation. Therefore, a component called the topology loader 232 may take the partial topology and convert it into a full topology by adding the appropriate data conversion transforms between the components in the partial topology.

In the topology 230, for example, data generally originates at the media source 210, flows through one or more transforms 218, and proceeds into one or more media sinks 220, 222. Transforms 218 can include any suitable data handling components that are typically used in presentations. Such components can include those that uncompress compressed data and/or operate on data in some way, such as by imparting an effect to the data, as will be appreciated by the skilled artisan. For example, for video data, transforms can include those that affect brightness, color conversion, and resizing. For audio data, transforms can include those that affect reverberation and re-sampling. Additionally, decoding and encoding can be done by transforms.

Media sinks 220, 222 are typically associated with a particular type of media content. Thus, audio content might have an associated audio sink such as an audio renderer. Likewise, video content might have an associated video sink such as a video renderer. Additional media sinks can send data to such things as computer-readable media, e.g. a disk file and the like, stream the data over the network, such as broadcasting a radio program, and so on.

The media session 214 is a component which may schedule multiple presentations. Therefore, the media processor 212 may be used to drive a given presentation, and the media session 214 utilized to schedule multiple presentations. The media session 214, for instance, may change topologies that are rendered by the media processor 212 as previously described. For example, the media session 214 may change from a first topology that is rendered on the media processor 212 to a second topology such that there is no gap between the renderings of samples from the consecutive presentations that are described by the respective topologies. Thus, the media session 214 may provide a seamless user experience as the playback of the media moves from one presentation to another.

The source resolver 216 component may be utilized to create a media source 210 from URLs and/or byte stream objects. The source resolver 216 may provide both synchronous and asynchronous ways of creating the media source 210 without requiring prior knowledge about the form of data produced by the specified resource.

In at least one embodiment, the media foundation 204 is utilized to abstract away the specific details of the existence of and interactions between various components of the media foundation 204. That is, in some embodiments, the components that are seen to reside inside the media foundation 204 are not visible, in a programmatic sense, to the application 202. This permits the media foundation 204 to execute so-called “black box” sessions. For example, the media engine 208 can interact with the media session 214 by providing the media session certain data, such as information associated with the media (e.g. a URL) and the destination 224, and can forward the application's 202 commands (e.g. open, start, stop and the like) to the media session 214. The media session 214 then takes the provided information and creates an appropriate presentation using the appropriate destination. Thus, the media foundation 204 may expose a plurality of software components that provide media functionality over an application programming interface for use by the application 202.

The sequencer source 122 may also be utilized to write media sources for specific timeline object models. For example, if a movie player has a proprietary file format which is used to represent its timeline, the movie player may use the sequencer source 122 to create a “stand alone” media source which will render its presentation to the media foundation 204. Therefore, an application which uses media foundation 204 may then play the movie player's file directly as it plays any other media file.

Additionally, the media foundation 204 allows 3^{rd} parties to register a particular file type based on its extension, scheme, header, and so on. For instance, the 3^{rd} party may register an object called a “byte stream plug-in” which understands the file format. Therefore, when a file of this particular format is found it creates the registered byte stream plug-in and asks it to create a media source which can source media samples from the file. Continuing with the previous example, the movie player may register a byte stream plug-in for its particular file type. When this byte stream plug-in is invoked, it may parse the media timeline and “figure out” the topologies which form the presentation. The plug-in may then queue the topologies on the sequencer source and rely on the sequencer source to playback the topologies back-to-back. To the application 202, it looks like any other media source for a file was given to the media foundation 204 and is played back just as a normal audio or video file.

FIG. 3 is an illustration of an exemplary implementation of a system 300 that shows interaction between the application 202, sequencer source 122 and media session 214 of FIG. 2. As illustrated in FIG. 3, the application 202 may be in contact with both the sequencer source 122 and the media session 214 to cause the media timeline 120 to be rendered.

The arrows of the system depict how data, control and status flow between the components of the system 300. For example, the application 202 is illustrated as being in contact with the media session 214. Arrow 302 represents communication of control information from the application 202 to the media session 214 through an application programming interface. A variety of control information may be communicated by the application 202 to the media session 214, such as to “set” a topology on the media session 214, call “start” to initiate rendering of a set topology, call “stop” to terminate rendering of the set topology, and so on. Arrow 304 represents the flow of status information from the media session 214 to the application 202, such as acknowledging that a topology has been set, “start” or “stop” calls have been implemented, current status of rendering of a topology by the media session 214, and so forth.

The application 202 is also illustrated as being in contact with the sequencer source 122. Arrow 306 represents communication of partial topologies from the application 202 to the sequencer source 122 and arrow 308 represent communication of status information from the sequencer source 122 to the application 202. As previously described, for instance, the application 202 may segment the media timeline 120 and queue the segments to the sequencer source 122 for rendering. The sequencer source 122 may then fire out events to notify the media processor and the media session that new presentations are available for rendering. These presentations are then picked up by the session, resolved, and queued up to be given to the processor once the rendering of the current presentation is completed, further discussion of which may be found in relation to FIG. 4.

The sequencer source 122 may also be viewed as a media source by the media session 214. For example, the sequencer source 122 may set a topology on the media session 214 which specifies that the source of the media is the sequencer source 122. The sequencer source 122 may then aggregate media from a plurality of media sources (e.g., media sources 210(1), 210(2)) and provide the media from the media sources to the media processor 212. In an implementation, the sequencer source 122 may aggregate media of different types and have that media appear as a single media source. For example, the samples may flow directly from the media sources 210(1), 210(2) to the media processor, and from the media process to the media session to be given to bit pumps, which is illustrated by arrows 310-314. The sequencer source 122 may timestamp samples received by the media sources 210(1), 210(2) and provide these samples to the media processor 212 for concurrent rendering. The sequencer source 122 may also control the operation of the media sources, 210(1), 210(2), which is illustrated in FIG. 3 by arrows 316, 318, respectively. A variety of other examples are also contemplated.

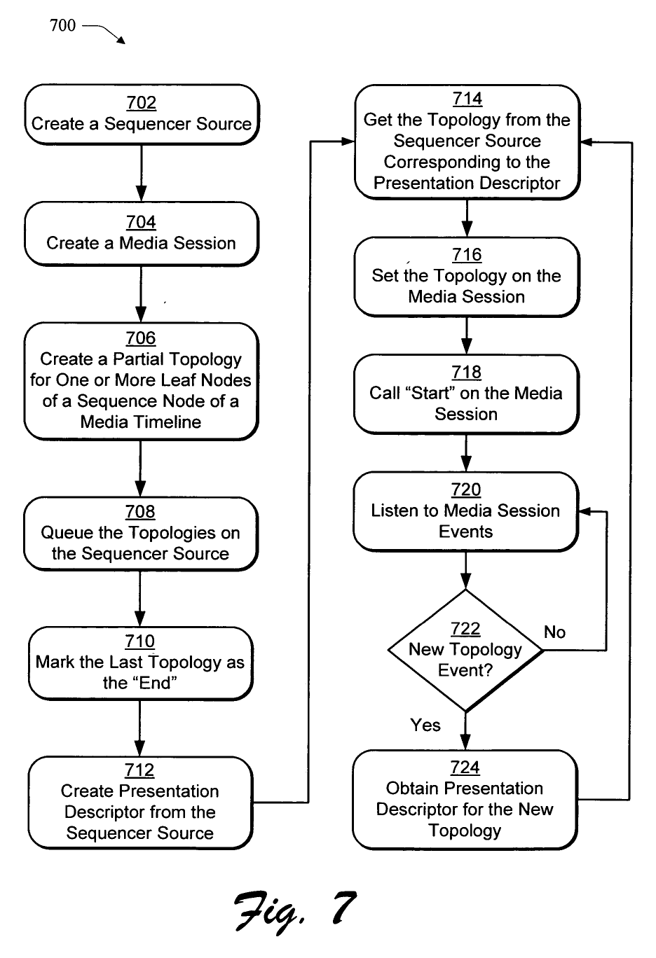

The media session 214 may also be executed to control operation of the sequencer source 122, which is illustrated by arrow 320 as a flow of control information from the media session 214 to the sequencer source 122. For example, the media session 214 may receive a “start” call to begin rendering a topology. The topology may specify that the sequencer source 122 as a media source in the topology. Therefore, the media processor 212, when rendering the topology, may call “start” on the sequencer source 122 to provide the samples represented in the topology. In this instance, the sequencer source 122 also calls “start” on the media sources 210(1), 210(2) and thereafter provides aggregated and time stamped samples back to the media session 214. Thus, in this instance the media session 214 is not “aware” that the sequencer source 122 is providing samples from a plurality of other media sources. Further discussion of media timeline 120 rendering may be found in relation to FIG. 7 after discussion of a variety of exemplary media timelines that may be processed using the infrastructure.

Media Timelines

FIG. 4 is an illustration of an exemplary implementation in which a media timeline 400 is shown as a tree that includes a plurality of nodes that describe an output of media for a presentation. The media timeline 400, which may or may not correspond to the media timeline 120 of FIGS. 1 and 2, is structured as a tree that includes a plurality of nodes 402-412. Each of the plurality of nodes 402-412 includes respective metadata 414-422 that describes various attributes and behaviors for the node and/or “children” of that particular node. For example, node 404 and node 406 are arranged, respectively, as a “parent” and “child”. Node 404 includes metadata 416 that describes behaviors and attributes of that node 404. The metadata 416 may also describe each of the “child” nodes 406, 408, such as a rendering order of the nodes 406, 408.

In an implementation, the media timeline 400 is not executable by itself to make decisions about a user interface (UI), playback or editing. Instead, the metadata 414-424 on the media timeline 400 is interpreted by the application 202. For example, the media timeline 400 may include one or more proprietary techniques to define presentation of the media referenced by the timeline. The application 202 may be configured to utilize these proprietary techniques to determine a “playback order” of the media, further discussion of which may be found in relation to FIGS. 7-11.

The nodes 402-412, as positioned on the media timeline 400, describe a basic layout of the media timeline 400. This layout may be utilized for displaying a timeline structure. For instance, various types of nodes 402-412 may be provided such that a desired layout is achieved. The node type indicates how the children of that node are interpreted, such as a root node 402 and leaf nodes 408-412. The root node 402 in this instance specifies a starting point for rendering the metadata timeline 400 and includes metadata 414 that describes how rendering is to be initiated.

In the illustrated implementation of FIG. 4, the leaf nodes 408, 410, 412 of the media timeline 120 directly map to media. For example, the leaf nodes 408, 410, 412 may have respective metadata 420, 422, 424 that describes how to retrieve the media that each of the leaf nodes 408-412 represent. A leaf node may specify a path for an audio and/or video file, point to a component which generates video frames programmatically during rendering of the media timeline 400, and so on. Leaf node 408, for instance, includes metadata 420 having a pointer 426 that maps to input device 108(1) that is configured as a microphone. Leaf node 410 includes metadata 422 having a pointer 428 that maps to an address of the media 430 in a storage device 432 that is included locally on the computer 102 of FIG. 1. Leaf node 412 includes metadata 424 having a pointer 434 that maps to a network address of the remote computer 114 on the network 112. The remote computer 114 includes the video camera 116 to provide media over the network 112 to the computer 102 of FIG. 1. Thus, in this implementation, the timeline 400 does not include the actual media, but rather references the media by using pointers 426, 428, 434 that describe where and/or how to locate the referenced media.

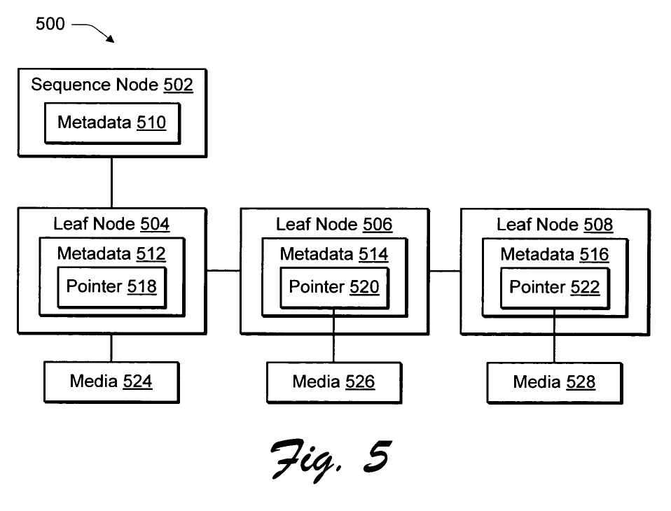

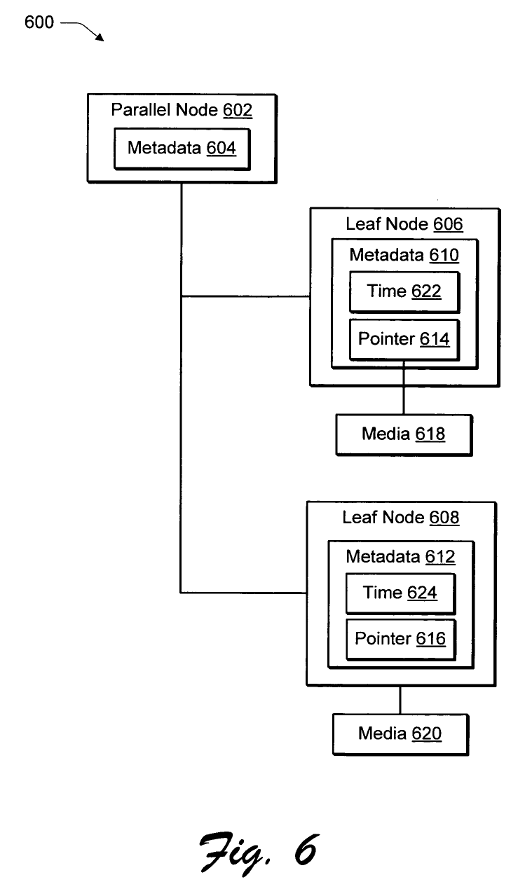

Nodes 404, 406 may also describe additional nodes of the media timeline 400. For example, node 404 may be utilized to describe the order of execution for nodes 406, 408. In other words, node 404 acts as a “junction-type” node to provide ordering and further description of its “children”. There are a variety of junction-type nodes that may be utilized in the media timeline 400, such as a sequence node and a parallel node. FIGS. 5-6 describe exemplary semantics behind the sequence and parallel nodes.

FIG. 5 is an illustration of an exemplary implementation 500 in which a sequence node 502 and a plurality of leaf nodes 504, 506, 508 that are children of the sequence node 502 are shown. The children of the sequence node 502 are rendered one after the other. Additionally, the sequence node 502 may include metadata 510 that describes a rendering order of the plurality of leaf nodes 504-508. As illustrated, leaf node 504 is rendered first, followed by leaf node 506, which is followed by leaf node 508. Each leaf node 504-508 includes respective metadata 512, 514, 516 having respective pointers 518, 520, 522 to respective media 524, 526, 528. Thus, the sequence node 502 may represent the functionality of a linear playlist of files.

Although the child nodes of the sequence node 502 are configured as leaf nodes in this implementation, child nodes of the sequence node 502 may represent any other type of node. For example, child nodes may be utilized to provide a complex tree structure as shown in FIG. 4. Node 406 of FIG. 4, for instance, is the child of another junction-type node, i.e. node 404.

FIG. 6 is an illustration of an exemplary implementation 600 in which a parallel node 602 includes metadata 604 specifying a plurality of leaf nodes 606, 608 that are children of the parallel node 602 are shown. In the previous implementation that was described in relation to FIG. 5, sequence nodes were discussed in which nodes that are children of the sequence node were rendered, one after another. To provide rendering of nodes at the same time, the parallel node 602 may be employed.

The children of the parallel node 602 may be rendered simultaneously. For example, leaf node 606 and leaf node 608 are children of parallel node 602. Each of the leaf nodes 606, 608 includes respective metadata 610, 612 having respective pointers 614, 616 to respective media 618, 620. Each of the leaf nodes 606, 608 includes a respective time 622, 624 included in the respective metadata 610, 612 that specifies when the respective leaf nodes 606, 608 are to be rendered. The times 622, 624 on the leaf nodes 606, 608 are relative to the parallel node 602, i.e. the parent node. Each of the child nodes can represent any other type of node and combinations of nodes, providing for a complex tree structure with combined functionality. For example, a “junction” type node may also reference media, and so forth. Although metadata including time data has been described, a variety of metadata may be included on nodes of the media timeline, an example of which is described in the following implementation.

Although a few examples of media timelines were described in relation to FIGS. 4-6, a variety of other media timelines may be processed utilizing the described infrastructure without departing from the spirit and scope thereof.

Exemplary Procedures

The following discussion describes processing techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment, systems and timelines of FIGS. 1-6.

FIG. 7 is a flow diagram depicting a procedure 700 in an exemplary implementation in which an application interacts with a media session and a sequencer source to cause a media timeline configured as a playlist to be rendered. An application creates a sequencer source (block 702) and a media session (block 704). For example, the application may make a “create” call to an API of the media foundation 204.

The application creates a partial topology for each segment of a media timeline (block 706). For example, in this implementation the media timeline is configured as a playlist, which may be represented by the media timeline 500 of FIG. 5 which includes a sequence node 502 and a plurality of leaf nodes 504-508. As previously described each of the leaf nodes 504, 506, 508 includes a respective pointer 518, 520, 522 which references a respective media item 524, 526, 528.

The application then creates a partial topology for one or more leaf nodes of the sequence node of the media timeline (block 706). In this embodiment, for instance, the media timeline 120 is a playlist which references media that is to be played in sequence, one media item after another. Therefore, each leaf node is the media timeline 120 represents a partial topology for playback of the media timeline. In another example, if the timeline specifies a cross fade between two left nodes, there will be topologies where both leaf nodes are used during the cross fade. In a first example, an effect can be specified for a small duration of the leaf node. For instance, if the leaf node represents media which is 10 seconds long and the timeline specifies a fadeout effect on the last five seconds of the leaf node, then this will result in two topologies, the first one does not include the effect and the second one does.

The application queues the topologies on the sequencer source (block 708) and the last topology is marked as the “end” (block 710). For example, a flag may be set on the last topology such that the sequencer source ends playback after that “flagged” topology is rendered.

A presentation descriptor is then created from the sequencer source (block 712). The presentation descriptor describes the media stream objects (hereinafter “media streams”) which are to be rendered. As previously described, media streams are objects which produce/receive media samples. A media source object may produce one or more media streams. Accordingly, the presentation descriptor may describe the nature of these streams, such as location of the streams, formats, and so on.

The application then obtains the topology from the sequencer source which corresponds to the presentation descriptor (block 714). For example, the application may communicate the presentation descriptor to the sequencer source and receive a topology corresponding to the presentation descriptor. In another example, the sequencer source may “set” the topology on the media session. In addition, the obtained topology may be configured in a variety of ways. For example, the obtained topology may be a partial topology that is resolved into a full topology by the topology loader 232 of FIG. 2. In another example, the sequencer source 122 may incorporate the functionality of the topology loader to resolve the partial topology to a full topology, which is then obtained by the media session 214. A variety of other examples are also contemplated.

The topology is then set on the media session (block 716). For example, the media session 214 may include a queue for topologies such that the topologies may be rendered in sequence, one after the other, without encountering a “gap” between the rendering of the topologies. Therefore, the application may call the media session to “set” a first one of the queued topologies to be rendered and call “start” on the media session to begin the rendering (block 718).

During the rendering, the application may “listen” for media session events (block 720). For example, the application 202 may receive status events from the media session 214 as illustrated by arrow 304 of FIG. 3. The application may then determine if a “new topology” event is received (decision block 722). If not (“no” from decision block 722), the application may continue “listening” to the events.

When a “new topology” event is received (“yes” from decision block 722), a presentation descriptor is obtained for the new topology (block 724). The topology from the sequencer source is obtained which corresponds to the presentation descriptor (block 714) and a portion (blocks 714, 716, 720-724) of the procedure 700 is repeated for the new topology. In this way, the application 202, sequencer source 122 and media session 214 may provide a sequential playback of a playlist. In some instances, however, parallel rendering is described which involves multiple media sources and complex topologies. Similar functionality may be employed in such an instance, further discussion of which may be found in relation to the following figures.

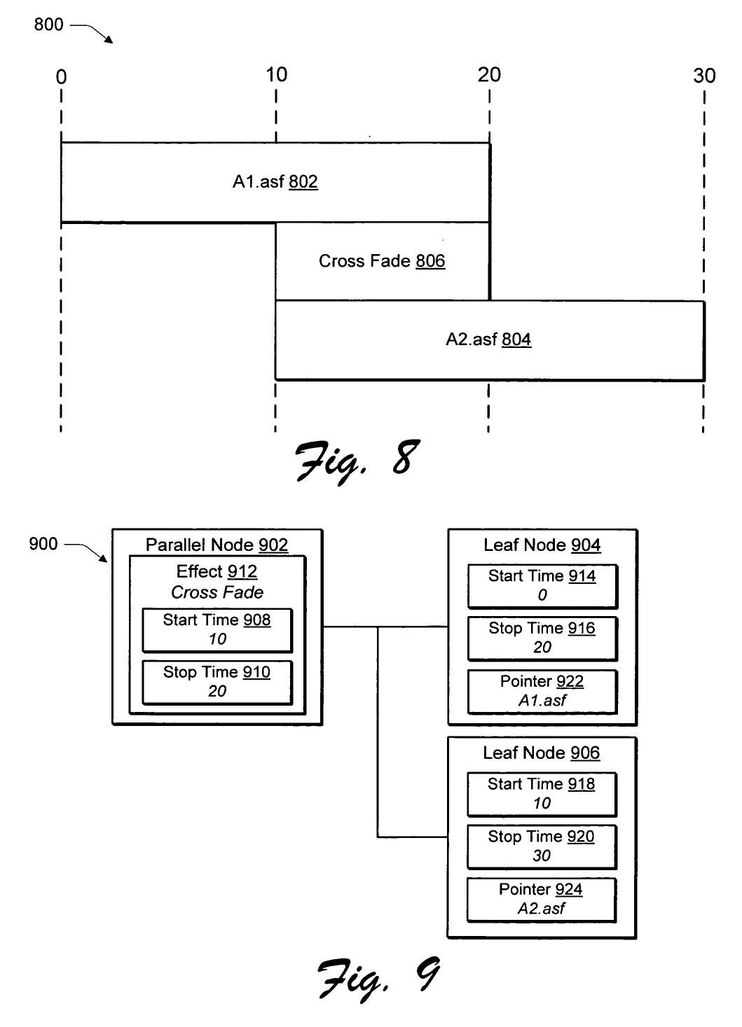

FIG. 8 is an illustration of an exemplary implementation showing an output 800 of first and second media over a specified time period that utilizes an effect to transition between the first and second media. In the illustrated example, A1.asf 802 and A2.asf 804 are two different audio files. A1.asf 802 has an output length 20 seconds and A2.asf 804 also has an output length 20 seconds. A cross fade 806 effect is defined between the outputs of A1.asf 802 and A2.asf 804. In other words, the cross fade 806 is defined to transition from the output of A1.asf 802 to the output of A2.asf 804. The cross fade 806 effect is initiated at 10 seconds into the output of A1.asf 802 and ends at the end of the output of A1.asf 802. Therefore, the output of A2.asf 804 is also initiated at 10 seconds. The cross fade 806 is shown as inputting two different media, i.e. A1.asf 802 and A2.asf 804, and providing a single output having the desired effect.

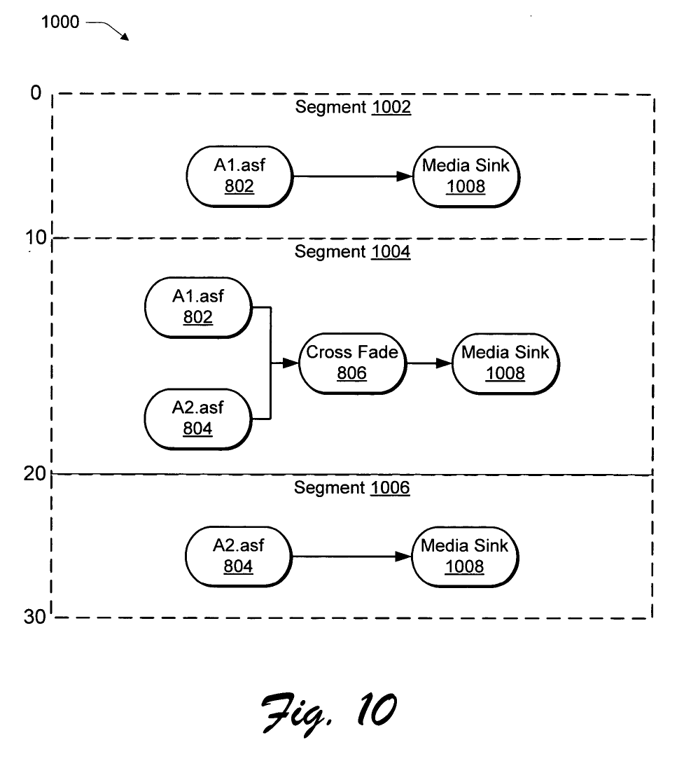

FIG. 9 is an illustration of a media timeline 900 in an exemplary implementation that is suitable to implement the cross fade 806 effect of FIG. 8. The media timeline 900 includes a parallel node 902 having two children, i.e. leaf nodes 904, 906. The parallel node 902 includes metadata that specifies a start time 908 of zero seconds and a stop time 910 of twenty seconds. The parallel node 902 also includes a composite effect 912 that describes a cross fade. The leaf node 904 includes metadata indicating a start time 914 of zero seconds and a stop time 916 of twenty seconds. Leaf node 906 includes metadata having a start time 918 of ten seconds and a stop time 920 of thirty seconds.

Leaf node 904 also includes a pointer 922 that references the A1.asf 802 file described in relation of FIG. 8. Likewise, leaf node 906 includes a pointer 924 that references the A2.asf file 804 that was described in relation to FIG. 8. Thus, when the media timeline 900 is executed, the A1.asf 802 file and the A2.asf file 804 are output in a manner that employs the effect 912 as shown in FIG. 8.

The application 202, to play (i.e., render) the media timeline 900 of FIG. 9, derives a plurality of segments, during which, components rendering during the segment do not change, i.e., each component is rendered for the duration of the segment and components are not added or removed during the segment. An example of segments the media timeline 900 of FIG. 9 is shown in the following figure.

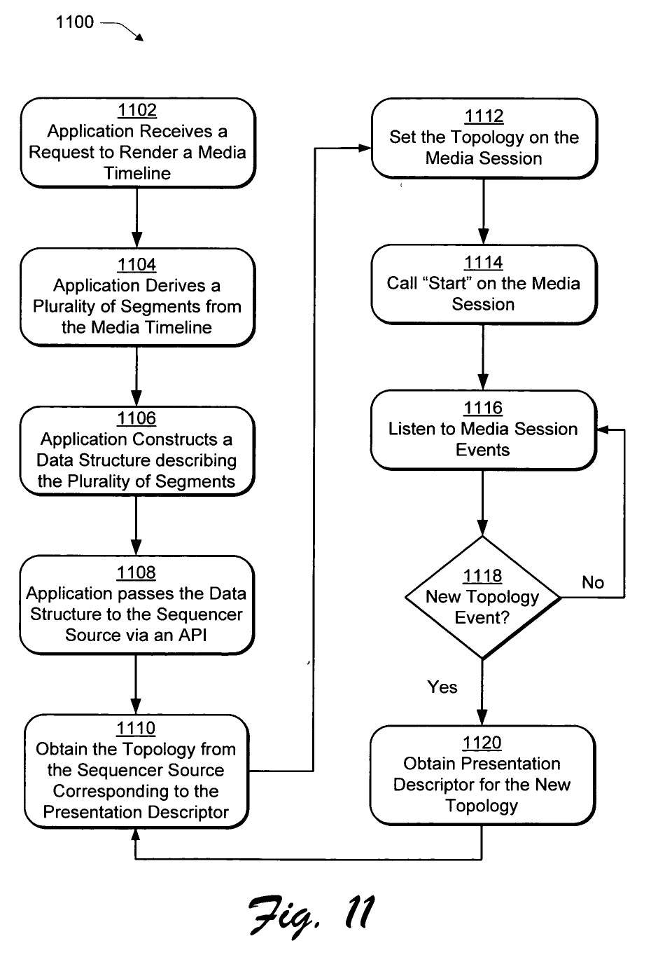

FIG. 10 is an illustration of an exemplary implementation 1000 showing a plurality of segments derived from the media timeline 900 of FIG. 9 by an application for rendering by the media timeline processing infrastructure. As previously described, the application may segment the media timeline 900 into a plurality of topologies for rendering by the media timeline processing infrastructure. In an implementation, each segment describes a topology having components, the rendering of which, do not change for the duration of the segment.

The media timeline 900 of FIG. 9, for example, may be divided into a plurality of segments 1002, 1004, 1006. Segment 1002 specifies that audio file A1.asf 802 is rendered to a media sink 1008 between a time period from “0” to “10”. Segment 1004 describes application of the cross fade 806 effect to transition between the output of audio file A1.asf 802 and audio file A2.asf 804 which occurs during a time period from “10” to “20”. Accordingly, the topology shown in segment 1004 illustrates an output from audio file A1.asf 802 and an output from audio file A2.asf 804 as being provided to the cross fade 806 effect, the output of which is then provided to the media sink 1008. Segment 1006 describes the rendering (i.e., “playing”) of the audio file A2.asf 804 during a time period between “20” and “30”. To play the media timeline 900 of FIG. 9, the application 202 queues the topologies shown in segments 1002-1006 to be rendered by the media session 214, further discussion of which may be found in relation to the following exemplary procedure.

FIG. 11 is a flow diagram depicting a procedure 1100 in an exemplary implementation in which an application segments a media timeline into a plurality of topologies for rendering by the media timeline processing infrastructure. An application receives a request to render a media timeline (block 1102). For example, the application may be configured as a media player. The media player may output a user interface (e.g., a graphical user interface) having a plurality of playlists for user selection. Therefore, a user may interact with the user interface to select one of the plurality of playlists to be output by the application.

The application then derives a plurality of segments from the media timeline (block 1104). For example, the application may determine which components are utilized during the rendering of the media timeline for a particular duration. The application may then determine segments of the duration which reference media items which do not change during the duration of the segment, i.e., media items are not added or removed during the segment.

Once the media timeline has been segmented, the application constructs a data structure describing the plurality of segments (block 1106). For example, the application may segment the media timeline 900 of FIG. 9 into the plurality of segments 1002-1006 of FIG. 10. Each of the plurality of segments includes a topology of components which are utilized to render the referenced media for that segment. Accordingly, each of these topologies may be entered into a data structure (e.g., an array) which references the components needed to render the media and also describes interactions between the components. For example, segment 1004 describes a topology which defines an output from audio file A1.asf 802 and an output from audio file A2.asf 804 as being provided to the cross fade 806 effect, the output of which is then provided to the media sink 1008. A variety of other examples are also contemplated.

The application then passes the data structure to the sequencer source via an application programming interface (API) (block 1108). As previously described in relation to FIG. 7, the application then obtains the topology from the sequencer source which corresponds to a presentation descriptor (block 1110). For example, the application may communicate the presentation descriptor to the sequencer source and receive a topology corresponding to the presentation descriptor. In another example, the sequencer source may “set” the topology on the media session. In addition, the obtained topology may be configured in a variety of ways. For example, the obtained topology may be a partial topology that is resolved into a full topology by the topology loader 232 of FIG. 2. In another example, the sequencer source 122 may incorporate the functionality of the topology loader to resolve the partial topology to a full topology, which is then obtained by the media session 214. A variety of other examples are also contemplated.

The topology is then set on the media session (block 1112). For example, the media session 214 may include a queue for topologies such that the topologies may be rendered in sequence, one after the other, without encountering a “gap” between the rendering of the topologies. Therefore, the application may call the media session to “set” a first one of the queued topologies to be rendered and call “start” on the media session to begin the rendering (block 1114).

During the rendering, the application may “listen” for media session events (block 1116). For example, the application 202 may receive status events from the media session 214 as illustrated by arrow 304 of FIG. 3. The application may then determine if a “new topology” event is received (decision block 1118). If not (“no” from decision block 1118), the application may continue “listening” to the events. If so (“yes” from decision block 1118), a new presentation descriptor for the new topology is obtained (block 1120) and a portion of the procedure 1100 is repeated.

A variety of media timelines may be rendered by the media timeline processing infrastructure. For example, a media timeline may be “event based” such that an author may specify the started of media based on an event. For instance, at time “12 am” start playing audio file “A1.asf”. These object modes may queue media on the sequencer source during playback, and can cancel or update topologies which have already been queued as previously described.

Exemplary Operating Environment

The various components and functionality described herein are implemented with a number of individual computers. FIG. 12 shows components of a typical example of a computer environment 1200, including a computer, referred by to reference numeral 1202. The computer 1202 may be the same as or different from computer 102 of FIG. 1. The components shown in FIG. 12 are only examples, and are not intended to suggest any limitation as to the scope of the functionality of the invention; the invention is not necessarily dependent on the features shown in FIG. 12.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, network-ready devices, minicomputers, mainframe computers, distributed computing environments that include any of the above systems or devices, and the like.

The functionality of the computers is embodied in many cases by computer-executable instructions, such as software components, that are executed by the computers. Generally, software components include routines, programs, objects, components, data structures, etc. that perform particular tasks or implement particular abstract data types. Tasks might also be performed by remote processing devices that are linked through a communications network. In a distributed computing environment, software components may be located in both local and remote computer storage media.

The instructions and/or software components are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 12, the components of computer 1202 may include, but are not limited to, a processing unit 1204, a system memory 1206, and a system bus 1208 that couples various system components including the system memory to the processing unit 1204. The system bus 1208 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 1202 typically includes a variety of computer-readable media. Computer-readable media can be any available media that can be accessed by computer 1202 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1202. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1206 includes computer storage media in the form of volatile and/or nonvolatile memory such as read only memory (ROM) 1210 and random access memory (RAM) 1212. A basic input/output system 1214 (BIOS), containing the basic routines that help to transfer information between elements within computer 1202, such as during start-up, is typically stored in ROM 1210. RAM 1212 typically contains data and/or software components that are immediately accessible to and/or presently being operated on by processing unit 1204. By way of example, and not limitation, FIG. 12 illustrates operating system 1216, application programs 1218, software components 1220, and program data 1222.

The computer 1202 may also include other removable/non-removable, volatile/nonvolatile computer storage media. By way of example only, FIG. 12 illustrates a hard disk drive 1224 that reads from or writes to non-removable, nonvolatile magnetic media, a magnetic disk drive 1226 that reads from or writes to a removable, nonvolatile magnetic disk 1228, and an optical disk drive 1230 that reads from or writes to a removable, nonvolatile optical disk 1232 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1224 is typically connected to the system bus 1208 through a non-removable memory interface such as data media interface 1234, and magnetic disk drive 1226 and optical disk drive 1230 are typically connected to the system bus 1208 by a removable memory interface.

The drives and their associated computer storage media discussed above and illustrated in FIG. 12 provide storage of computer-readable instructions, data structures, software components, and other data for computer 1202. In FIG. 12, for example, hard disk drive 1224 is illustrated as storing operating system 1216′, application programs 1218′, software components 1220′, and program data 1222′. Note that these components can either be the same as or different from operating system 1216, application programs 1218, software components 1220, and program data 1222. Operating system 1216′, application programs 1218′, software components 1220′, and program data 1222′ are given different numbers here to illustrate that, at a minimum, they are different copies. A user may enter commands and information into the computer 1202 through input devices such as a keyboard 1236, and pointing device (not shown), commonly referred to as a mouse, trackball, or touch pad. Other input devices may include source peripheral devices (such as a microphone 1238 or camera 1240 which provide streaming data), joystick, game pad, satellite dish, scanner, or the like. These and other input devices are often connected to the processing unit 1202 through an input/output (I/O) interface 1242 that is coupled to the system bus, but may be connected by other interface and bus structures, such as a parallel port, game port, or a universal serial bus (USB). A monitor 1244 or other type of display device is also connected to the system bus 1208 via an interface, such as a video adapter 1246. In addition to the monitor 1244, computers may also include other peripheral rendering devices (e.g., speakers) and one or more printers, which may be connected through the I/O interface 1242.

The computer may operate in a networked environment using logical connections to one or more remote computers, such as a remote device 1250. The remote device 1250 may be a personal computer, a network-ready device, a server, a router, a network PC, a peer device or other common network node, and typically includes many or all of the elements described above relative to computer 1202. The logical connections depicted in FIG. 12 include a local area network (LAN) 1252 and a wide area network (WAN) 1254. Although the WAN 1254 shown in FIG. 12 is the Internet, the WAN 1254 may also include other networks. Such networking environments are commonplace in offices, enterprisewide computer networks, intranets, and the like.

When used in a LAN networking environment, the computer 1202 is connected to the LAN 1252 through a network interface or adapter 1256. When used in a WAN networking environment, the computer 1202 typically includes a modem 1258 or other means for establishing communications over the Internet 1254. The modem 1258, which may be internal or external, may be connected to the system bus 1208 via the I/O interface 1242, or other appropriate mechanism. In a networked environment, program modules depicted relative to the computer 1202, or portions thereof, may be stored in the remote device 1250. By way of example, and not limitation, FIG. 12 illustrates remote software components 1260 as residing on remote device 1250. It will be appreciated that the network connections shown are exemplary and other means of establishing a communications link between the computers may be used.

As previously described, the application programs 1218, 1218′ may also provide media timelines for rendering by the media foundation 204 of FIG. 2. Exemplary implementations of media timelines may be found in relation to the following figures.

Exemplary Media Timeline Implementations

The media timelines previously discussed may employ a variety of methods of storing and restoring timeline data, such as one or more Windows® Media Player Playlist files, eXecutable Temporal Language (XTL) files, and so on.

A media timeline, for instance, may be described as the following Windows® Media Player Playlist file identified by an ASX file extension.

<Asx Version = “3.0”>
<Entry>
<Ref href = “file://\\wmp\content\mpeg\Boom.mpe”/>
</Entry>
<Entry>
<Ref href = “\\wmp\content\Formats\MovieFile\chimp.mpg”/>
</Entry>
<Entry>
<Ref href = “file://\\wmp\content\mpeg\Boom.mpe”/>
</Entry>
</Asx>

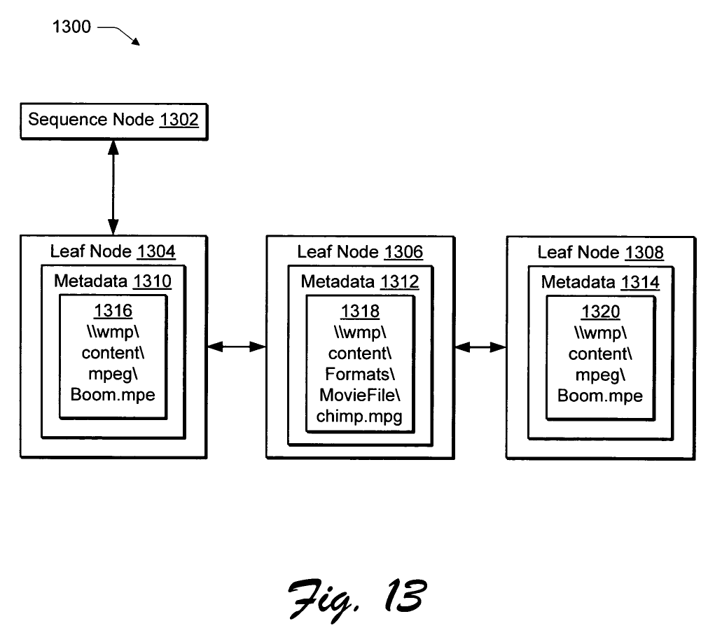

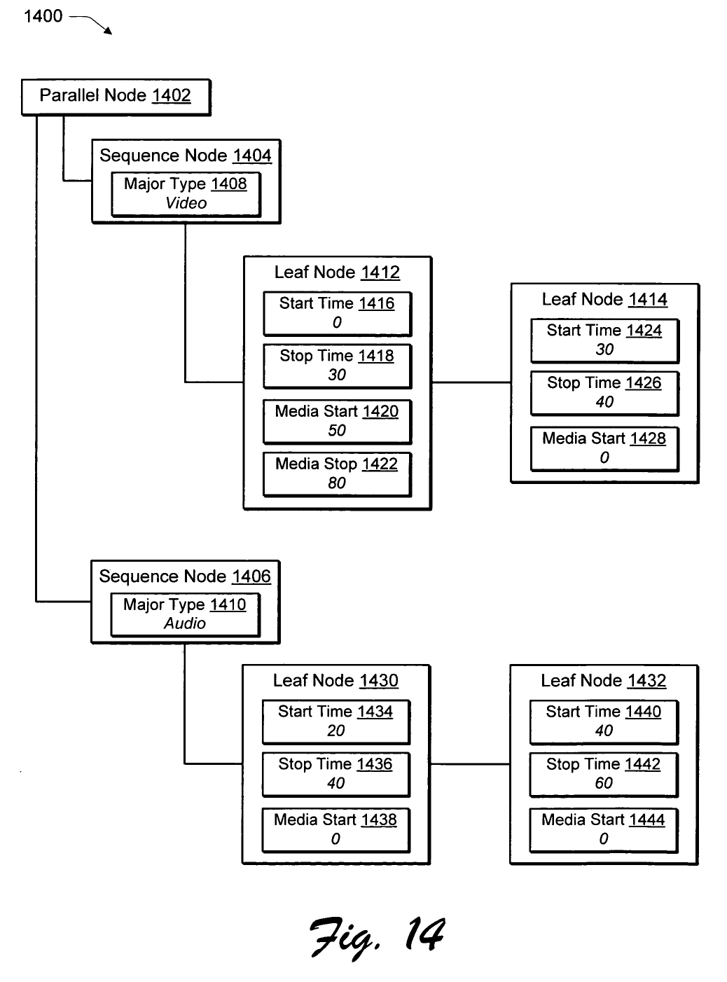

This ASX file specifies three files for output, back to back. No start and stop times have been specified for the files. The ASX file may be represented by the media timeline 1300 shown in FIG. 13 that includes a sequence node 1302 and three leaf nodes 1304, 1306, 1308. Each of the leaf nodes 1304-1308 includes respective metadata 1310, 1312, 1314 that describes respective sources 1316, 1318, 1320 for media to be output by the media timeline 1300.

Another example of a media timeline is shown in the following XTL file.

<timeline>
<group type=″video″>

<track>

<clip src=″V1.wmv″ start=″0″ stop=″30″ mstart=″50″ mstop=”80”
/>
<clip src=”V2.wmv” start=”30” stop=”40” mstart=”0” />

</track>

</group>
<group type=″audio″>

<track>

<clip src=″A1.asf″ start=″20″ stop=″40″ mstart=″0″ />
<clip src=”A2.asf” start=”40” stop=”60” mstart=”0” />
</track>
</group>
</timeline>

This XTL file describes two tracks, e.g., streams, of media for output. One of the tracks is an audio track and the other is a video track.

The XTL file may be represented by the media timeline 1400 that is shown in FIG. 14 that includes a parallel node 1402 having two child sequence nodes 1404, 1406. In this example, sequence node 1404 has a major type 1408 filter set as “video” and sequence node 1406 has a major type 1410 filter set as “audio”. Sequence node 1404 has two child leaf nodes 1412, 1414. Leaf node 1412 includes metadata that specifies a start time 1416 of “0”, a stop time 1418 of “30”, a media start 1420 of “50”, and a media stop 1422 as “80”. Leaf node 1414 include metadata that specifies a start time 1424 of “30”, a stop time 1426 of “40”, and media start 1428 as “0”. It should be noted that leaf node 1414 does not include a media stop time, therefore the entire length of the media referenced by the leaf node 1414 will be output.

Sequence node 1406 also has two child leaf nodes 1430, 1432. Leaf node 1430 includes metadata that specifies a start time 1434 of “20”, a stop time 1436 of “40”, and a media start 1438 of “0”. Leaf node 1432 include metadata that specifies a start time 1440 of “40”, a stop time 1442 of “60”, and media start 1444 of “0”.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising executing an application to:
derive a plurality of segments from a media timeline, wherein:
the media timeline references a plurality of media; and
each said segment references media to be rendered during a duration of the segment; and
queue the plurality of segments via an application programming interface for rendering by an infrastructure.

2. A method as described in claim 1, wherein the media timeline references at least two different types of media.

3. A method as described in claim 1, wherein the application is not configured to render the media itself.

4. A method as described in claim 1, wherein the application is not aware of how one or more said media are rendered by the infrastructure.

5. A method as described in claim 1, wherein the plurality of segments are queued for rendering by the infrastructure in a data structure that is exposed via the application programming interface by the infrastructure to the application.

6. A method as described in claim 1, wherein the media timeline utilizes one or more proprietary techniques for describing the media timeline that are not exposed by the application to the infrastructure.

7. A method as described in claim 1, further comprising changing a topology of at least one said segment while another said segment is being rendered through interaction of the application with the infrastructure via the application programming.

8. A method as described in claim 1, further comprising receiving a request to render the media timeline via a user interface output by the application.

9. A method comprising:
receiving a request to render a media timeline by an application, wherein the media timeline:
includes a plurality of nodes; and
defines a presentation of a first media referenced by a first said node with respect to a second media referenced by a second said node;
deriving a plurality of segments from the media timeline by the application, wherein each said segment includes one or more nodes that are rendered during a duration of the segment; and
passing the plurality of segments via an application programming interface by the application for rendering by an infrastructure such that the application is not aware of how one or more said media are rendered by the infrastructure.

10. A method as described in claim 9, wherein the plurality of segments are queued for rendering by the infrastructure in a data structure that is exposed via an application programming interface by the infrastructure to the application.

11. A method as described in claim 10, further comprising changing a topology of at least one said segment while another said segment is being rendered through interaction of the application with the infrastructure via the application programming.

12. A method as described in claim 9, wherein the media timeline utilizes one or more proprietary techniques for describing the media timeline that are not exposed by the application to the infrastructure.

13. A method as described in claim 9, wherein the application is not aware of how one or more said media are rendered by the infrastructure.

14. A method as described in claim 9, wherein the application is not configured to render the media itself.

15. One or more computer readable media comprising computer executable instructs that, when executed, provide an infrastructure having an application programming interface that is configured to accept a plurality of segments from an application for sequential rendering, wherein each said segment:
references at least one media item for rendering by the infrastructure; and
is segment from a media timeline by an application.

16. One or more computer readable media as described in claim 15, wherein the plurality of segments are queued for rendering by the infrastructure in a data structure that is exposed via the application programming interface to the application.

17. One or more computer readable media as described in claim 16, wherein the infrastructure is configured to accept a change made by the application to a topology of at least one said segment while another said segment is being rendered.

18. One or more computer readable media as described in claim 15, wherein the media timeline utilizes one or more proprietary techniques for describing the media timeline that are not exposed by the application to the infrastructure.

19. One or more computer readable media as described in claim 15, wherein the application is not aware of how one or more said media are rendered by the infrastructure.

20. One or more computer readable media as described in claim 15, wherein the application is not configured to render the media itself.
